(19) United States
(12) Patent Application Publication
(10) Pub. No.: US 2010/0030927 A1
(43) Pub. Date: Feb. 4, 2010

(54) GENERAL PURPOSE HARDWARE ACCELERATION VIA DEIRECT MEMORY ACCESS

(75) Inventor: Benjamin Heard, Raleigh, NC (US)

Correspondence Address: POTOMAC PATENT GROUP PLLC, P. O. BOX 270, FREDERICKSBURG, VA, 22404, US

(73) Assignee: TELEFONAKTIEBOLAGET LM ERICSSON (PUBL), Stockholm (SE)

(21) Appl. No.: 12/181,749

(22) Filed: Jul. 29, 2008

(51) Int. Cl. G06F 13/28

(52) U.S. Cl. 710/23

(57) ABSTRACT

A method and system in which one or more hardware accelerators are directly accessible via a direct memory access controller (DMAC) including an internal mechanism. In some embodiments, the internal mechanism may include a local interconnect in the DMAC. In other embodiments, a DMAC structure includes a mechanism that provides for streaming data through hardware accelerators and allows for simultaneous reads and writes among multiple endpoint pairs transferring data. For added flexibility and increased independence from a microprocessor, a DMAC may include a command decoder that discovers, decodes and interprets commands in a data stream.

### FIELD OF THE INVENTION

The present invention relates to methods and systems for moving data between system components, and more particularly, to Direct Memory Access (DMA) and a DMA controller (DMAC).

### BACKGROUND

Modern computers implement DMA as an efficient mechanism to move data around a system. Unlike programmable input/output (PIO) which uses a processor to move small bits of data following a set of executed instructions, a DMAC is used to move large amounts of data without processor intervention, and to thus leave the processor free to perform other tasks for which it is better suited.

A DMAC is a specialized processor whose sole purpose is to move data throughout a system without microprocessor intervention. While a microprocessor is able to move data, it is limited in performance because the computation of addresses from which to read data and to which to write data consume a large portion of the overall number of instructions necessary to move a piece of data.

For example, a microprocessor will execute an instruction to read from address a. Then, it will execute an instruction to write that data to address b. Next, it will execute an instruction that will increment a to a+1. Finally, the microprocessor executes an instruction to increment b to b+1. In this example, the movement of data takes two cycles (read and write) and the overhead is an additional two cycles (incrementing). So, the movement of data is only 50% efficient in the processor.

The specialized DMAC, however, computes addresses during the data movement. Accordingly, in theory a DMAC may be 100% efficient as compared with the microprocessor described above. In practical applications, even DMACs have some overhead. However, they are still far more efficient at moving data than a microprocessor.

Modern computers also employ hardware acceleration to speed processing of data. Hardware accelerators are specialized functions that implement data processing applications faster than their microprocessor counterparts. Common examples of hardware accelerators are digital signal processors (DSP), error correction code (ECC) generators and checkers, encryption or decryption blocks, packet processing engines, and cyclic redundancy code (CRC) checkers.

For large amounts of data, DMA is used to move data between memory and the hardware accelerators. A typical data flow would be to first move data from a peripheral device into memory using DMA. Next, the data would be moved from memory to a hardware accelerator. Finally, the data converted by the accelerator would be moved from the accelerator to its final location in memory.

Similar to the relationship between a microprocessor and a DMAC, a microprocessor is able to perform the function of the hardware accelerator but has not been designed specifically to do so. Therefore, a hardware accelerator will process data far more quickly and efficiently.

Modern computer implementations include systems on chips (SoC), which typically include a microprocessor, DMAC, input/output devices, and multiple hardware accelerators connected to one another and system memory through a shared interconnect. This shared interconnect, however, suffers from the limited resource it is. For instance, when many devices are trying to communicate with one another, the shared interconnect becomes a source of congestion that slows down communication, and thus performance in the system. Also, as data are processed by either the processor or the hardware accelerators, they must move from memory to the processor/accelerator, and back, which consumes time and adds to an overall decrease in performance when processing the data.

FIG. 1a is a diagram of a SoC 100 that illustrates congestion and performance issues associated with a Shared Interconnect 110. Attached to the shared interconnect 110 is a microprocessor, or CPU 112, a DMAC 114, Input/Output Devices 116, System Memory 118 and Hardware (HW) Accelerators (Acc.) 120-122. In a first scenario, it is assumed data are coming onto the SoC from the Internet. These data are encrypted so they must pass through HW Acc. 120 to be decrypted before they may be operated on by the microprocessor 112. The traditional approach to process these data is shown in FIG. 1b, and proceeds as follows:

1) The microprocessor 112, knowing that data shall arrive, programs the DMAC 114 with the necessary information to move data that appears at an input device 116 into System Memory 118. This configuration traffic passes over the Shared Interconnect 110.

2) The microprocessor 112, knowing that the data must be decrypted configures HW Acc. 120 to be able to decrypt the incoming data. This traffic also passes over the Shared Interconnect 110.

3) The Microprocessor 112 then configures another channel in the DMAC 114 to move data from System Memory 118 to HW Acc. 120, and configures a third channel to move data from HW Acc. 120 back to System Memory 118. These configuration efforts also use the Shared Interconnect 110.

4) Now, when data appear on the Input Device 116, the Input Device 116 interrupts the DMAC 114. The DMAC 114, using the configuration from 1), moves the data to System Memory 118.

5) Once all of the data are moved, the DMAC 114 interrupts the Microprocessor 112 to indicate such.

6) The Microprocessor 112 then enables the channel in 3) to move data from system memory to HW Acc. 120. Again, once complete, the DMAC 114 interrupts the Microprocessor 118 to indicate that it has finished.

7) Finally, the Microprocessor 112 enables the last channel in 3) to move the decrypted data back from HW Acc. 120 to System Memory 118. And, as above, the DMAC 114 interrupts the Microprocessor 112 when it has completed.

In all, there are four configuration streams (at 1), 2), and twice at 3)), three interrupts to the microprocessor (at 5), 6) and 7)), and the data moves across the Shared Interconnect 110 three times (at 4), 6) and 7)).

In this common scenario, the Microprocessor 112 directs all of the data processing by coordinating with the DMAC 114 to configure and enable channels in sequence, moving through each step in response to an interrupt from the DMAC 114. This coordination effort consumes resources in the Microprocessor 112 that may otherwise be used for other computation or may be turned off completely for power savings.

This sequence also consumes the Shared Interconnect 110 a substantial amount and ties up access to the System Memory 118 as data are moved back and forth from device and to HW Acc. 120. This transfer consumes unnecessary power and limits other devices ability to simultaneously access the System Memory 118 which will impact performance.

Additionally, many SoCs use external, or “off-chip,” memory as system memory. Access to this memory located off chip takes a large number of system clock cycles and consumes unnecessary power.

U.S. Patent Application Publication No. 2008/0005390 A1 to Couvert et al. describes a SoC DMAC that includes a plurality of interfaces connected to respective hardware modules for processing data during a transfer between an external memory and system memory. However, although the Couvert et al. system reduces involvement of the CPU when a data stream is supplied to a hardware module, the CPU remains considerably involved at other times during data transfer processes.

### SUMMARY

Embodiments in accordance with the invention generally relate to moving and processing data using a programmable direct memory access controller (DMAC) architecture that allows for greater independence from CPU involvement when processing data between source and destination endpoints.

In some aspects, a method of moving data between a plurality of source and destination device endpoint pairs in a computing system includes programming a plurality of channels in a direct memory access controller (DMAC). Each of the channels is configured by the programming to move a data sequence from a source device to a destination device of a respective endpoint pair. At least one of the channels is configured in a single configuration transaction and includes a path through a hardware accelerator between the source and destination devices of the respective endpoint pair for processing the sequence of data of that channel. Accordingly, the transfer of data requires only one single configuration transaction, for example, with a CPU, to move and process the data between devices, such as peripheral input/output devices, system memory etc.

In another aspect, an embodiment of a DMAC comprises a first interface that receives programming information for configuring a plurality of channels. Each of these programmed channels moves a data sequence from a source device to a destination device of a respective endpoint pair. At least one of the channels is configured in a single configuration transaction that provides a path transfer path from the source device, through a hardware accelerator that processes the data sequence of that channel, and then to the destination device. Accordingly, the DMAC transfer and processing of data requires only one single configuration transaction, for example, with a CPU, when moving and processing the data between endpoint devices.

In yet another aspect of the invention, one of a read or a write operation may be performed simultaneously by the DMAC on the source or destination device of at least two of the endpoint pairs. Thus, the DMAC method and device can be used to more efficiently transfer data between multiple device endpoint pairs with minimal CPU involvement.

Other aspects of the invention involve a method of moving data between devices of a device endpoint pair that comprise monitoring a stream of data to detect the presence of an embedded command. Recognized commands are decoded to direct the processing of the data stream through a hardware accelerator located in a path between the device endpoint pair according to the decoded command. Decoding commands from a data stream allows for greater flexibility and increased DMAC independence from CPU control. For example, it may allow for a single source to route data to several destinations, allow parts of a single thread of data to be processed through different HW accelerator blocks in the DMAC, or allow the processing to efficiently change “on the fly” as the data is received.

In another aspect, an embodiment of a DMAC includes state machine control logic for managing tasks for the DMAC, at least one protocol master for receiving and transmitting data streams between endpoint device pairs external to the DMAC, and a command decoder that decodes commands embedded in a data stream received at one of the protocol masters. The state machine control logic processes the data stream through a hardware accelerator located in a path configured by the DMAC between devices of an endpoint pair according to a command decoded by the command decoder.

It is to be understood that both the foregoing general description and the following detailed description are exemplary and exemplary only and are not restrictive of the invention, as claimed.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention. In the drawings:

FIG. 1a is a diagram showing a direct memory access controller (DMAC) in a current system implementation.

FIG. 1b is a diagram showing a typical data movement scenario of the system shown in FIG. 1a.

FIG. 2 is a diagram of a computing system including a DMA subsystem in which the hardware (HW) functionality of an accelerator provided in the DMAC in accordance with an exemplary embodiment.

FIG. 3 is a diagram showing the internal architecture of a DMAC in accordance with some embodiments.

FIG. 4 is a diagram depicting a timing sequence of an exemplary peripheral-to-memory data transfer according to some embodiments.

FIG. 5 is a diagram depicting a timing sequence of an exemplary peripheral-to-memory data transfer that includes HW acceleration according to some embodiments.

FIG. 6 is a diagram of a DMAC in accordance with exemplary embodiments in which the hardware (HW) acceleration functionality is accessed through a local interconnect.

FIG. 7 is a diagram depicting an exemplary timing sequence of a peripheral-to-memory data transfer performed by a DMAC using a local interconnect.

FIG. 8 is a diagram of an exemplary DMAC provided with data streaming capability.

FIG. 9 is a diagram of a DMAC provided with data streaming capability in accordance with an exemplary embodiment.

### DETAILED DESCRIPTION

The various aspects are described hereafter in greater detail in connection with a number of exemplary embodiments to facilitate an understanding of the invention. However, the invention should not be construed as being limited to these embodiments. Rather, these embodiments are provided so that the disclosure will be thorough and complete, and will fully convey the scope of the invention to those skilled in the art.

Many aspects of the invention are described in terms of sequences of actions to be performed by elements of a computer system or other hardware capable of executing programmed instructions. It will be recognized that in each of the embodiments, the various actions could be performed by specialized circuits (e.g., discrete logic gates interconnected to perform a specialized function), by program instructions, such as program modules, being executed by one or more processors, or by a combination of both. Moreover, the invention can additionally be considered to be embodied within any form of computer readable carrier, such as solid-state memory, magnetic disk, and optical disk containing an appropriate set of computer instructions, such as program modules, and data structures that would cause a processor to carry out the techniques described herein. A computer-readable medium would include the following: an electrical connection having one or more wires, magnetic disk storage, magnetic cassettes, magnetic tape or other magnetic storage devices, a portable computer diskette, a random access memory (RAM), a read-only memory (ROM), an erasable programmable read-only memory (EPROM or Flash memory), or any other medium capable of storing information. Thus, the various aspects of the invention may be embodied in many different forms, and all such forms are contemplated to be within the scope of the invention.

Furthermore, it should be emphasized that the terms “comprises” and “comprising,” when used in this specification, are taken to specify the presence of stated features, integers, steps or components; but the use of these terms does not preclude the presence or addition of one or more other features, integers, steps, components or groups thereof.

The invention makes one or more hardware accelerators directly accessible by the DMA through an internal mechanism. Thus, the data are accelerated in hardware directly in the path from the peripheral to memory. This “in-path” acceleration eliminates the movement of data from memory to the accelerator and from the accelerator back to memory.

In some embodiments, the invention provides an interface to multiple hardware modules, which allows for configuring simultaneous read and write operations among multiple system endpoint pairs including these modules or other devices such as memory.

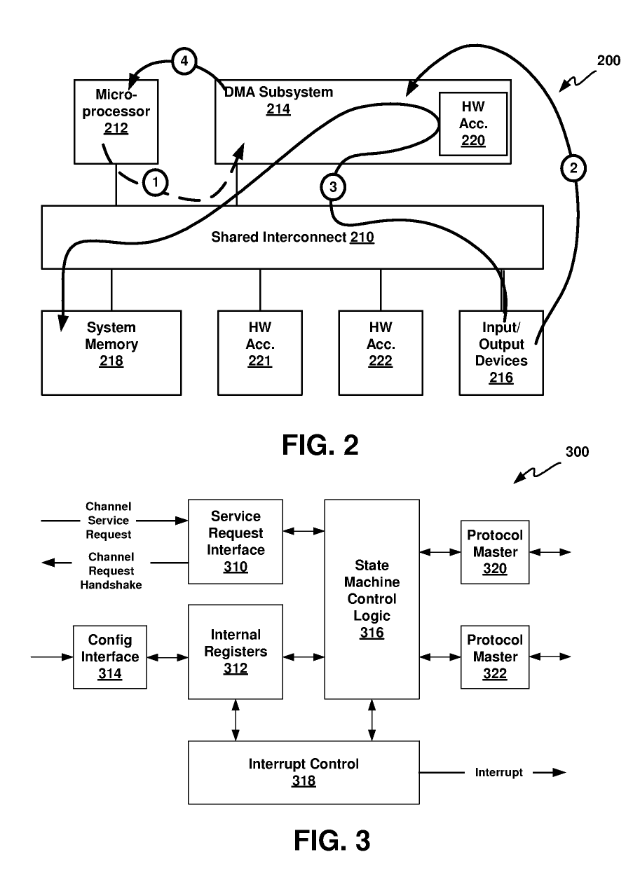

FIG. 2 shows a computing system 200 according to some embodiments of the invention. As shown in FIG. 2, computing system 200 includes a Shared Interconnect 210, to which is attached a Microprocessor 212, Input/Output Devices 216, System Memory 218 and Hardware (HW) Accelerators (Acc.) 221-222. The hardware acceleration functionality of a HW Acc. 220 is moved inside the DMAC, thus creating a DMA subsystem 214. This configuration would require less intervention by the Microprocessor 212, consume fewer resources of the Shared Interconnect 210, and free the System Memory 218 to be used simultaneously by other devices.

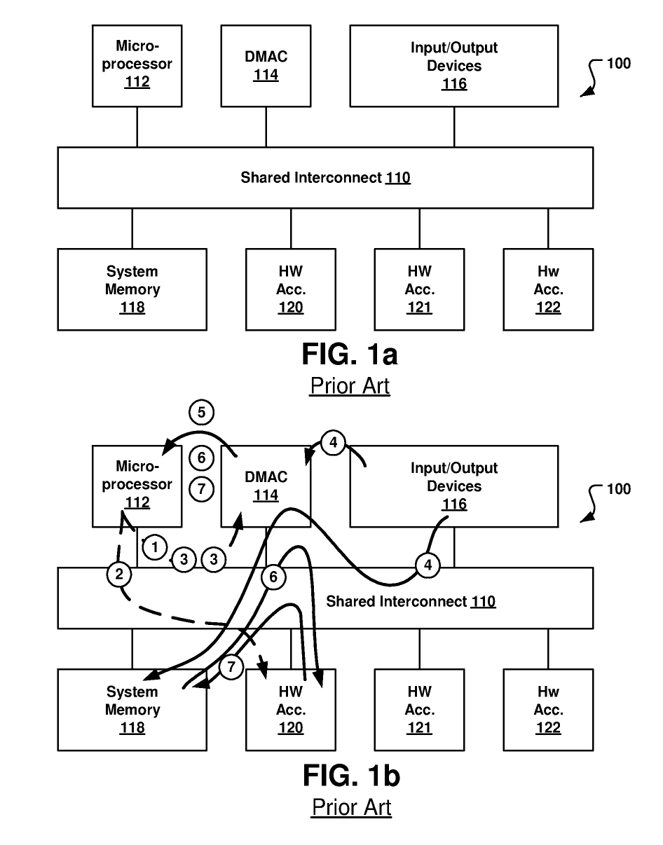

The data movement of FIG. 2 is illustrated in a manner similar to FIG. 1b. However, because the system 200 has a HW Acc. 220 is provided inside the DMA subsystem 214, the number of processes involved in moving data is reduced, as follows:

1) The Microprocessor 212 knows data shall arrive and programs the DMA subsystem 214 with the necessary information to move data that appears at an Input Device 216 into System Memory 218. This configuration step also tells the DMA subsystem 214 to route these data through the hardware accelerator 220. This configuration traffic passes over the Shared Interconnect 210.

2) When data appear at the input device, the DMA subsystem is interrupted.

3) Using the configuration from 1, the DMA subsystem 214 moves all data from the input device through its internal HW Acc. 220 and out to System Memory 218.

4) Once all of the data specified in the configuration from 1 have been moved, the DMA subsystem 214 interrupts the Microprocessor 212 informing it that the data have been moved.

As can be seen above, moving a hardware accelerator or other data processing module into the DMAC reduces the number of processes that would otherwise be required and increases the availability of the interconnect. In all, there are now only 1 configuration stream, 1 interrupt to the Microprocessor 212, and the data moves across the Shared Interconnect 210 once.

FIG. 3 shows internal architecture of a multi-channel SoC DMAC 300. The multi-channel DMAC 300 includes a Service Request Interface 310, which is used by other devices to request DMA services and by the DMAC to acknowledge each request when a DMA channel has been configured for peripheral-flow-control. The Internal Registers 312 are configured through the Config Interface 314 and may be updated as DMA tasks complete by the State Machine Control Logic 316, which is connected to the service Request Interface 310 and the Internal Registers 312. The Interrupt Control 318 is connected to both the Internal Registers 213 and the State Machine Control Logic 316, and allows the DMA to signal that tasks have been completed and whether errors have occurred.

The main function of the DMAC 300 resides in the State Machine Control Logic 316 and the Protocol Masters 320, 322. When a channel is configured in the Config Interface 314 and enabled for transfer, the State Machine Control Logic 316 inspects whether the channel is ready to perform a task. If one or both endpoints in the channel are peripherals that require flow control, the State Machine Control Logic 316 queries the endpoints ready state through the service request logic of the Service Request Interface 310 (a ready endpoint will assert a request to the Service Request Interface 310 when it's ready). If the endpoints are both memory they are assumed always ready and no inspection of the Service Request Interface 310 would be performed.

Once the endpoint pair in a channel is ready, the DMAC 300 issues reads to satisfy the movement of the amount of data commanded in the Internal Registers 312. The DMAC 300 also issues corresponding writes, which may commence when data from a read operation appears at the DMAC 300. The two Protocol Masters 320, 322 are used in any combination as needed to satisfy the configured channel. For example, the reads may occur on one Protocol Master 320, 322 and the writes may occur on the other 322, 320. Or, both the read and write may occur on the same protocol master.

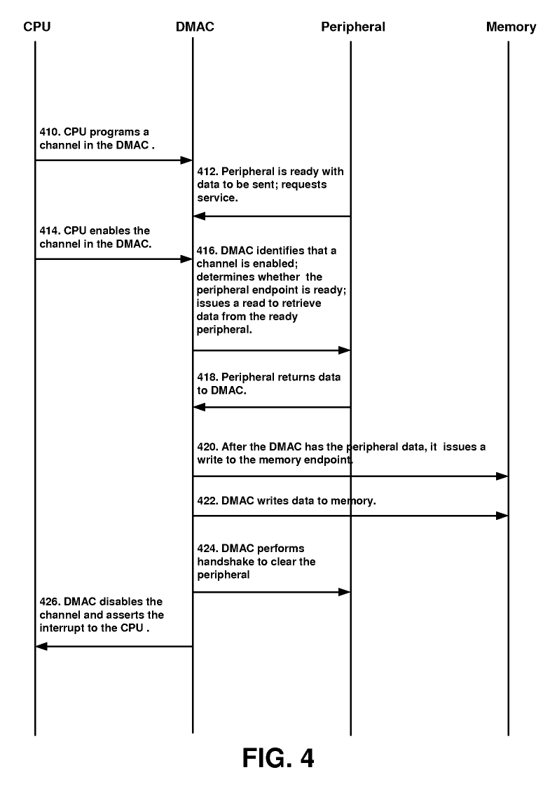

FIG. 4 is a diagram of an exemplary peripheral-to-memory transfer according to some embodiments, where a peripheral device is accessed through one protocol master and memory is accessed through another protocol master. It will be understood that the timing relationship between when reads and writes issue is dependent on the interconnect protocol and may or may not be in the specific depicted order. The only timing relationship is that data intended for memory may not be written until it is received from the peripheral. This example assumes that the DMAC has enough internal storage to hold all of the data requested from the peripheral before writing it out to memory.

With reference to FIGS. 2 to 4, the exemplary peripheral-to-memory transfer begins at process 410, where the CPU (i.e., Microprocessor) 212 programs a channel in the DMAC 300 through the Configuration (Config) Interface 314. The channel parameters are stored in the Internal Registers 312. In process 412, the peripheral device is ready with data to be sent to memory and requests service through the Service Request Interface 310, although in other embodiments a write operation may commence as soon as the data arrives at the DMAC 300.

In process 414, the CPU 212 enables the channel in the DMAC 300 through the Config Interface 314. Next, in process 416, the DMAC 300 identifies that a channel is enabled. Since one endpoint is a peripheral device (e.g., at 216), the DMAC 300 determines whether the peripheral device endpoint is ready, for example, by inspecting the Service Request Interface 310. Once ready, the DMAC 300 issues a read to retrieve data from the peripheral device.

In process 418, the peripheral device returns data to DMAC 300. Because the System Memory endpoint 218 is memory, the DMAC 300 assumes it is always ready. Now that it has the peripheral device's data, the DMAC 300 issues a write to the System Memory endpoint 218 in process 420, and writes data to the System Memory endpoint 218 in process 422.

After the write task is complete, the DMAC 300 performs a handshake in process 424 to clear the peripheral through the Service Request Interface. Thereafter, in process 426 the DMAC 300 disables the channel in the Internal Registers 312 because it is complete and asserts an interrupt to the CPU 212 through the Interrupt Control 318.

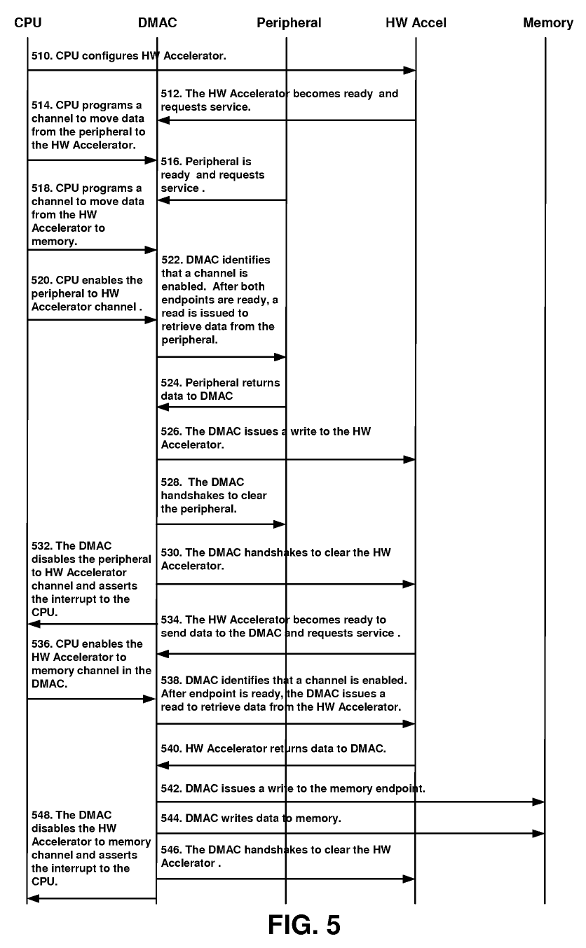

FIG. 5 is a diagram showing a peripheral-to-memory data transfer that includes hardware acceleration. The data transfer from the peripheral is read by the DMAC, processed by a hardware accelerator, and written to memory. A second DMAC channel is used because a first channel obtains data from the peripheral to the accelerator and the second channel moves data from the accelerator to memory. Each arrow in FIG. 5 indicates traffic that must traverse the system interconnect.

Starting with process 510, the CPU configures a HW accelerator for processing of data to be received from a peripheral device. At process 512, the HW accelerator becomes ready to receive data from the DMAC and requests service through the service request interface of the DMAC. In process 514, the CPU programs a channel in the DMAC through the configuration interface of the DMAC to move data from the peripheral to the HW accelerator, and the channel parameters are stored in the internal registers of the DMAC. When the peripheral is ready with data to be sent to memory, process 516 requests service though the service request interface. In process 518, the CPU programs a channel in the DMAC through its configuration interface to move data from the HW accelerator to memory and stores the channel parameters in the internal registers of the DMAC.

In process 520, the CPU enables the peripheral-to-HW accelerator channel in the DMAC through the configuration interface of the DMAC, although enabling the channel may be implied after it is programmed by the CPU. In the next depicted process 522, the DMAC identifies that a channel is enabled. In this embodiment, since both endpoints are peripheral devices, the DMAC inspects its service request interface to determine whether they are ready. Once ready, the DMAC issues a read to retrieve data from the peripheral, and the peripheral device returns data to DMAC in process 524.

In process 526, the DMAC knows that the HW accelerator endpoint is ready, and now that it has the peripheral device data, issues a write to the HW accelerator. 528. Now that the task is complete, the DMAC handshakes to clear the peripheral device through the service request interface. After completing the task, in process 530 the DMAC handshakes to clear the HW accelerator through the service request interface. In process 532, the DMAC disables the peripheral to HW accelerator channel in the DMAC internal registers because it is complete, and the DMAC asserts the interrupt to the CPU through its interrupt control. In process 534, the HW accelerator becomes ready to send data to the DMAC and requests service through the request service interface. At process 536, the CPU enables the HW accelerator-to-memory channel in the DMAC through its configuration interface. In process 538, the DMAC identifies that a channel is enabled. Since one endpoint is the HW accelerator, the DMAC inspects its service request interface to determine if the endpoint is ready. Once ready, the DMAC issues a read to retrieve data from the HW accelerator, and in process 540 the HW accelerator returns data to DMAC.

Process 542 includes the DMAC assuming that memory endpoint is always ready, and after it has the data from the peripheral device, the DMAC issues a write to the memory endpoint. Thereafter, in process 544, the DMAC writes data to memory. After the writing process completes, in process 546 the DMAC handshakes to clear the HW accelerator through the service request interface. In process 548, the DMAC disables the hardware accelerator-to-memory channel in the internal registers because it is complete and asserts the interrupt to the CPU through the DMAC interrupt control.

It will be appreciated that the order of processes described in connection with FIG. 5 is exemplary, and that the some processes may be combined and/or performed in an order different from that which is depicted. Additionally, some processes may be performed in parallel between multiple endpoint pairs actively exchanging data.

Embodiments of the invention include the hardware acceleration function in the DMAC. Some embodiments provide a local hardware accelerator interconnect inside the DMAC connects the protocol master ports of the DMAC to the hardware acceleration resources. Other embodiments do not use a local interconnect, and instead stream the data through the hardware accelerators, and the data are processed by a hardware accelerator as they traverse the master protocol ports of the DMAC.

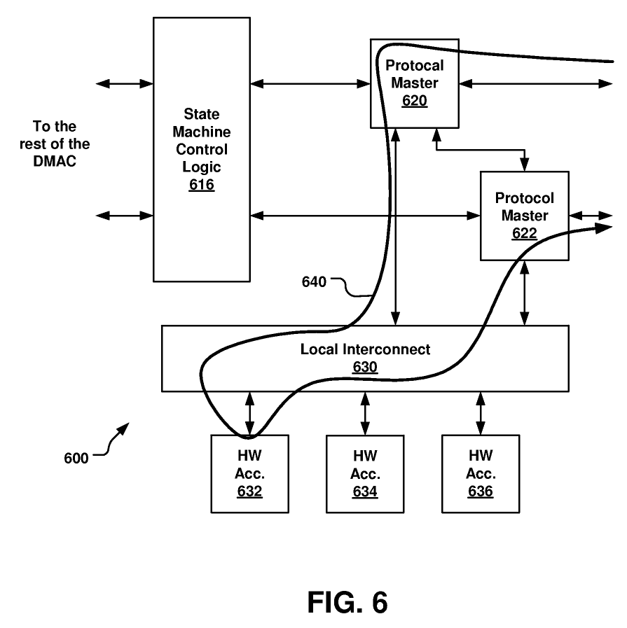

FIG. 6 is a diagram of a DMAC 600 according to some embodiments that include a local interconnect 630 connecting the protocol master ports 620 and 622 to hardware acceleration resources 632, 634 and 636. The DMAC 600 includes state machine control logic 616, which may be connected to a service request interface, internal registers and an interrupt control not shown in FIG. 6, but described above and shown in FIG. 4.

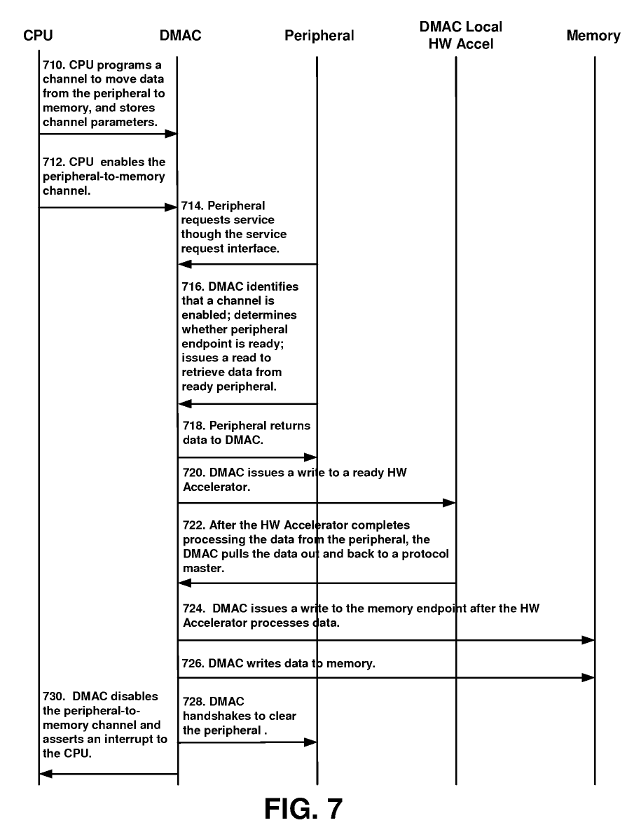

The number of transfer processes described in FIG. 5 may now be reduced to that shown in the sequence diagram of FIG. 7, and shown in FIG. 6 as one possible route 640 of the data. There is only a single configuration transaction that configures one channel in the DMAC to move data from a peripheral device to memory. This time, however, the data are to be moved through a hardware accelerator on the local interconnect.

The sequence shown in FIG. 7 begins at process 710 in which a CPU programs a channel in the DMAC through a configuration interface to move data from a peripheral device to memory through a HW accelerator. The channel parameters are stored in the internal registers of the DMAC. In process 712, the CPU enables the peripheral to memory channel in the DMAC through the configuration interface, although enabling this channel may be implied after it is programmed by the CPU. After the peripheral is ready with data to be sent to memory, in process 714, it requests service though the service request interface of the DMAC.

In process 716, the DMAC identifies that a channel is enabled. Because one endpoint is a peripheral device, the DMAC inspects the service request interface to determine whether the peripheral endpoint is ready. Once the peripheral is ready, the DMAC issues a read to retrieve data from the peripheral device, and the peripheral device returns data to DMAC in process 718. In process 720, the DMAC knows that the HW accelerator is ready, and now that it has the peripheral device data, it issues a write to the HW accelerator.

Once the HW Accelerator is complete with processing the data from the peripheral device, in process 722 the DMAC pulls the data out and back to the protocol master. In process 724, the DMAC assumes that memory endpoint is always ready, and now that it has the HW accelerator processed data, it issues a write to the memory endpoint. Thereafter, in process 726 the DMAC writes data to memory. Now that the writing task is complete, in process 728 the DMAC handshakes to clear the peripheral device through the service request interface. In process 730, the DMAC disables the peripheral-to-memory channel in the DMAC internal registers because it is complete, and the DMAC asserts the interrupt to the CPU through its interrupt control.

While the sequence of FIG. 7 appears similar to the sequence of FIG. 5, there are fewer interrupts and configuration transactions. Additionally, the communication of data to and from the hardware accelerator are internal to the DMAC and do not consume system interconnect resources. Also, although FIG. 6 shows the DMAC 600 implementing only one route 640 includes two channels through which the data flows, embodiments of the DMAC 600 may implement several channels (e.g., 90, 128 or more). For example, protocol master 622 could issue a read operation to retrieve data from an endpoint device (e.g., from a peripheral device or memory), perform a write of the data to the hardware accelerator 634, and the protocol master 620 performs a read on the hardware accelerator 634 to retrieve the processed data and then writes the data to another endpoint device. Data flows may occur between any of the hardware accelerators 632-636, through only one protocol master or a plurality of protocol masters, or simultaneously.

Embodiments that stream a hardware accelerator have the same functionality as embodiments using an internal interconnect to connect protocol master ports to the HW acceleration resources, but there is no longer an internal interconnect. Instead, the data are processed through a hardware accelerator as they traverse the protocol master ports. The sequence diagram would differ from that depicted in FIG. 7 in that communication with the hardware accelerator is no longer explicit. Rather, it occurs implicitly as data are passed across the DMAC protocol masters. For instance, an explicit addressing case may include a request made to a HW accelerator for a read/write operation based on an address decoded through the interconnect. The data are then transferred in response to that request. In the streaming case, addressing is implied when streaming data to a HW accelerator simply by routing the data to it. For example, the addressing of a HW accelerator may become a selection applied to a multiplexer (MUX) and the data are pumped to that HW accelerator for a duration corresponding to the amount of the data. This may involve a MUX control where 1-of-N HW accelerator is chosen. In this case, addressing is simplified and decoding is reduced to selection through a MUX.

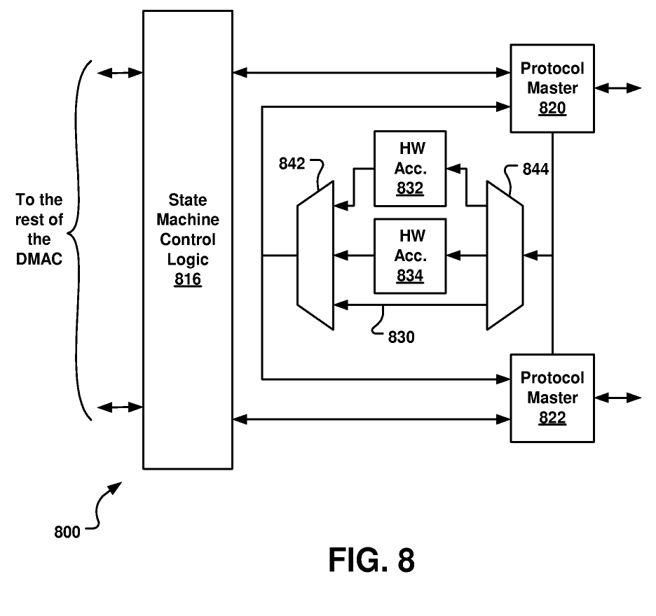

FIG. 8 is a diagram of a DMAC circuit 800 provided with data streaming capability. The DMAC circuit includes State Machine Control Logic 816, to which is connected dual Protocol Masters 820 and 822. The dual Protocol Masters 820 and 822 connect to one another and to HW Accelerators 832 and 834 through multiplexers 842 and 844. The DMAC circuit 800 provides a single interface to one or multiple HW accelerator devices, allows for simultaneous read and writes capabilities, and is capable of connecting multiple pairs of endpoints through different HW accelerators simultaneously.

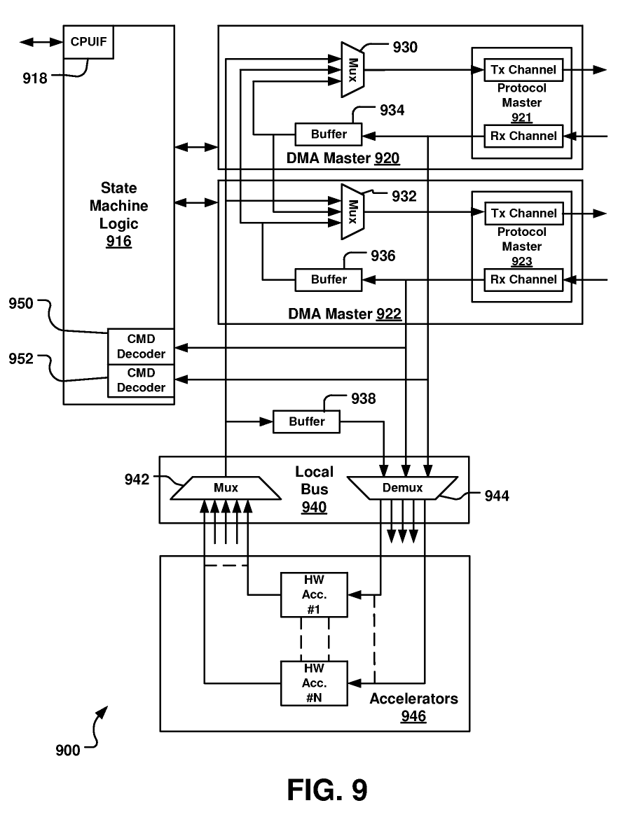

FIG. 9 is a diagram of a DMAC 900 according to some embodiments, which provides streaming capability between two or more arbitrary system memory locations. Similar to the DMAC 800, the DMAC 900 is capable of performing DMA read and write operations at the same time on different packets of data in a continuous manner. These different packets of data may be exchanged between respective pairs of a multiple of endpoint pairs.

The DMAC 900 includes State Machine Logic 916 that communicates with a first DMA Master 920, a second DMA Master 922, although more or less DMA Masters may be provided. The DMA Masters 920, 922 respectively include a Protocol Master 921 and 923, each having a transmitting (TX) port and a receiving (RX) port. The Protocol Masters 920, 922 communicate with a state Machine Logic 916, which includes a CPU interface CPUIF 918. The DMA Masters 920, 922 also may include respective multiplexers 930 and 932 for selecting one of the TX channels, and respective buffers 934 and 936 for buffering data received from the RX channels. Connected to each of the dual DMA Masters 920, 922 are multiplexers 942 and 944 of a local bus 940, which direct data in and out of HW Accelerator #1 to HW Accelerator #N in a bank of HW accelerators 946. The addressable local bus structure allows HW accelerator modules to be added to the DMAC. The Local Bus 940 may use one or more buffers 938, for example, to buffer data being cycled back through the demultiplexer 944 to another HW Acc.

One difference between an embodiment including a local DMAC interconnect and an embodiment in which data streams through the hardware accelerators is that the former requires no change to existing hardware accelerators. Since they are attached to an interconnect in much the same way as they would be in a traditional architecture, such as a SoC, no modification would be necessary for them to fit the new scheme.

The accelerators in a streaming embodiment require that data “stream” as a continuous sequence of data packets passing through one or a series of processing stages between a source system address and a destination system address. This “streaming” results in lower overhead and higher overall performance, but may require modification to the HW accelerators.

If modification of a HW accelerator would be necessary, the types of changes would correspond to the operation the HW accelerator is performing. For example, an embodiment may include a CRC generator. For the non-streaming case, the CRC generator would respond to a write request, store data in a register, accumulate the CRC value with these new data, and repeat until all data had been sent through the block. The CRC generator also would respond to a read request to fetch the calculated CRC value. In the streaming case, data would appear to the CRC generator without having been addressed. The CRC generator accepts the streamed data and accumulates the CRC value. Upon seeing the appropriate amount of data, the CRC value has been calculated and the generator passes this value out to the protocol master that is to write the data. Thus, differences in operation of the HW accelerator between the non-streaming and streamed cases can be characterized as a slave vs. slave and master. The non-streaming HW accelerator may act as a slave device only responding to requests, while a streaming version of the HW accelerator would have some master ability because it is able to write the results of a computation further downstream in the data movement processing.

FIG. 9 also illustrates an exemplary command decoding concept of the invention according to some embodiments. When data arrives at a RX Channel of one or both of the Protocol Masters 921, 923, the header or other field in a data packet or data thread may include a command that instructs the DMAC on how to move the data from point “A” to point “B,” for example, which HW accelerator to use in the data transfer between points A and B. The State Machine Logic 916 includes command (CMD) decoders 950, 952, which detect or recognize when a command is present either of the incoming data streams on RX channels and decode the commands, although more or less than two CMD detector/decoders may be provided in a DMAC and may be located elsewhere in a DMAC other than the State Machine Logic.

The CMD decoder may itself be a HW processor that decodes the data read, recognize DMA commands embedded in the thread and allow them to reprogram the DMA unit in real time. The CMD decoder allows for more DMAC independence from CPU control. For instance, it may allow for a single source to route data to several destinations, e.g., demux automatically, or allow parts of a single thread of data to be processed through different HW accelerator blocks in the DMAC.

It will be apparent to those skilled in the art that various changes and modifications can be made in the method and system for providing hardware acceleration via DMA of the present invention without departing from the spirit and scope thereof. Thus, it is intended that the present invention cover the modifications of this invention provided they come within the scope of the appended claims and their equivalents.

What is claimed is:

1. A method of moving data between a plurality of source and destination device endpoint pairs in a computing system, comprising:
programming a plurality of channels in a direct memory access controller (DMAC), each said channel configured by the programming to move a data sequence from a source device to a destination device of a respective endpoint pair;
wherein at least one of said channels is configured in a single configuration transaction and includes a path through a hardware accelerator between the source and destination devices of the respective endpoint pair for processing the sequence of data of that channel.

2. The method according to claim 1, wherein the DMAC includes a first and second protocol master, and the source and destination devices of each respective endpoint pair are accessed through one of the first and second protocol masters.

3. The method according to claim 1, wherein at least two said channels include different hardware accelerators.

4. The method according to claim 1, wherein data sequences are streamed through the plurality of channels.

5. The method according to claim 4, wherein the hardware accelerator is one of a plurality of selectable hardware accelerators located between a multiplexer/demultiplexer pair.

6. The method according to claim 1, wherein the DMAC includes a local interconnect in the path that connects the hardware accelerator with the source and destination devices.

7. The method according to claim 1, wherein one of a read or a write operation is performed simultaneously by the DMAC on the source or destination device of at least two of the endpoint pairs.

8. The method according to claim 7, wherein the simultaneous read or a write operations performed by the DMAC are respectively routed through at least one of a first and second protocol master.

9. A direct memory access controller (DMAC) for moving data between a plurality of source and destination device endpoint pairs, comprising:
a interface that receives programming information for configuring a plurality of channels, each said channel moving a data sequence from a source device to a destination device of a respective endpoint pair;
wherein at least one of said channels is configured in a single configuration transaction that provides a path through a hardware accelerator, which processes the data sequence of that channel and is located in the path between the source and destination devices of the respective endpoint pair.

10. The DMAC according to claim 9, further comprising a first and second protocol master, and the source and destination devices of each respective endpoint pair are accessed through one of the first and second protocol masters.

11. The DMAC according to claim 9, wherein at least two said channels include a path through different respective hardware accelerators.

12. The DMAC according to claim 9, wherein data sequences are streamed through the plurality of channels.

13. The DMAC according to claim 12, further comprising a multiplexer/demultiplexer pair, and the hardware accelerator is one of a plurality of selectable hardware accelerators located between said multiplexer/demultiplexer pair.

14. The DMAC according to claim 9, further comprising a local interconnect in the path that connects the hardware accelerator with the source and destination devices.

15. The DMAC according to claim 9, wherein the DMAC is configured to perform one of a read or a write operation simultaneously on the source or destination device of at least two of the endpoint pairs.

16. The DMAC according to claim 15, wherein the simultaneous read or write operations are respectively routed through at least one of a first and second protocol master.

17. A method of moving data between devices of a device endpoint pair, comprising:
monitoring a stream of data for an embedded command;
decoding a command found to be embedded in the data stream; and
processing the data stream through a hardware accelerator located in a path between the device endpoint pair according to the decoded command.

18. The method according to claim 17, wherein the processing is performed by a direct memory access controller (DMAC), which comprises at least two protocol masters, each said protocol master configured to receive and transmit a data stream.

19. The method according to claim 18, wherein received streaming data through each of the protocol masters is separately decoded.

20. A direct memory access controller (DMAC), comprising:
state machine control logic for managing tasks for the DMAC;
at least one protocol master for receiving and transmitting data streams between endpoint device pairs external to the DMAC; and
a command decoder that decodes commands embedded in a data stream received at the protocol master,
wherein the state machine control logic processes the data stream through a hardware accelerator located in a path configured by the DMAC between devices of an endpoint pair according to a command decoded by the command decoder.

21. The DMAC according to claim 20, further comprising a multiplexer/demultiplexer pair connected to each protocol master for selecting the hardware accelerator from a plurality of hardware accelerators connected therebetween, said selection based on information in a command decoded by the command decoder.

22. The DMAC according to claim 20, wherein the decoder is included with the state machine control logic.
